(19) United States
(12) Patent Application Publication
(10) Pub. No.: US 2016/0311494 A1
(43) Pub. Date: Oct. 27, 2016

(54) Unknown

(71) Applicant: Derby Cycle Werke GmbH, Cloppenburg (DE)

(72) Inventor: Frank SCHLIEWERT, Cloppenburg (DE)

(21) Appl. No.: 15/136,509

(22) Filed: Apr. 22, 2016

(30) Foreign Application Priority Data
Apr. 24, 2015 (DE) 20 2015 003 010.6

(51) Int. Cl. B62K 19/40; B62K 3/04

(52) U.S. Cl. CPC B62K 19/40; B62K 3/04; B62J 2099/004

(57) ABSTRACT

A vehicle frame, in particular a bicycle frame with frame tubes, in particular with a seat tube and a down tube. At least one frame tube has at least one mounting for at least one energy storage device. Provision is made for at least one mounting to be designed as a recess in at least one frame tube, for the frame tube to have at least one bounding surface bounding the recess in at least one or more sections, for the frame tube to have a locating edge bounding the recess in at least one or more sections, and for at least one bounding surface to have at least one clamping projection.

### BACKGROUND OF THE INVENTION

1. Field of the Invention

The invention concerns a vehicle frame, in particular a bicycle frame with frame tubes, in particular with a seat tube and a down tube, wherein at least one frame tube has a mounting for an energy storage device.

2. Brief Description of the Related Art

Vehicle frames, in particular bicycle frames, with mountings for purposes of housing at least one energy storage device, in particular a battery, are used in many circumstances, in particular on electric bicycles, such as, for example, pedelecs, s-pedelecs, e-bikes or similar. A battery required for purposes of operation can be attached by means of a mounting onto a frame tube, for example a down tube, such that the battery is easy to remove and the motion sequence, for example when riding a pedelec, is not impaired. When attaching a battery onto a bicycle frame it is of particular importance that it is not possible for the battery to be released from the bicycle frame, even when riding over uneven ground. A method of attachment that is very often used is an attachment by means of latching connections. However, these usually feature the disadvantage that the latching connections allow the battery to have a clearance relative to the bicycle frame, so that the result can be the generation of annoying noises, in particular rattling noises. In addition a battery attached to the bicycle frame should integrate into the overall visual impression of the bicycle. Here in particular a blending of the battery into the tube geometry of the bicycle frame is advantageous.

### SUMMARY OF THE INVENTION

The task underlying the invention is that of demonstrating a bicycle frame of the type cited in the introduction, by means of which a secure and visually unobtrusive housing of an energy storage device is made possible.

The solution of the task is undertaken with a vehicle frame with the features of patent claim 1. Further developments and advantageous configurations are specified in the respective subsidiary claims.

In a vehicle frame, in particular a bicycle frame with frame tubes, in particular with a seat tube and a down tube, wherein at least one frame tube has at least one mounting for at least one energy storage device, provision is made, in a manner significant to the invention, for at least one mounting to be designed as a recess in at least one frame tube, for the frame tube to have at least one bounding surface bounding the recess in at least one or more sections, and for at least one bounding surface to have at least one clamping projection. In particular the energy storage device can take the form of a rechargeable storage device for electrical energy, for example, a commercially available battery for pedelecs, electrical bicycles, e-bikes, or similar. The use of other energy storage elements such as, for example, batteries that are not rechargeable, is also conceivable. The battery that is used is preferably constructed in an elongated manner, is, for example, approximately cylindrical, and can have two end faces, that is to say, base surfaces, and one shell surface. The vehicle frame, in particular a bicycle frame for a pedelec or an s-pedelec, has frame tubes, for example a down tube, which for example, connects the head tube of the bicycle frame with the seat tube, that is to say, the bottom bracket bearing housing. The down tube is preferably embodied robustly such that the stability of the bicycle frame is not negatively affected by any recess that is present. The recess in a frame tube can, for example, be provided by a volume extracted from the frame tube, or an extracted tube section, wherein the frame tube has at least one, in particular two bounding surfaces. Bounding surfaces bound the recess in one or more sections, and are, for example, arranged to be at right angles to the surface of the frame tube. The recess is thus surrounded by the two bounding surfaces in one or more sections, and on one side by the remaining part of the down tube. For example, an edge length of the bounding surfaces can be two thirds of the inner diameter of the frame tube, while the edge of the bounding surface standing at right angles to the frame tube can correspond to the diameter of the frame tube in this dimension. It is preferable if the battery to be housed by the frame tube is designed such that it can be introduced into the recess flush with the surface of the frame tube, and can thus blend visually into the shape of the existing frame tube. At least one bounding surface, which bounds the recess in one or more sections, has at least one clamping projection. A clamping projection can, for example, be designed in the shape of a curved guide track. In particular, each of the bounding surfaces can have a clamping projection. Correspondingly, the energy storage device unit, in particular a battery, can have mating parts on its end faces. For the housing of the battery into the recess of the bicycle frame in at least one or more sections, the battery can be located on a locating edge of the bicycle frame. Here the locating edge runs, for example, parallel to the outer contour of the frame tube, and the battery can have a shape that is matched to that of the locating edge. By an approach of a non-located edge of the battery towards the free locating edge, particular as a result of rotation of the battery about an axis of rotation formed by the first locating edge, the battery is received into the recess of the frame tube in one or more sections. Here in particular the mating parts of the battery can be designed as sliding parts, which, as the battery rotates inwards, slide along the clamping projections of the bounding surfaces in at least one or more sections. Here the clamping projections are designed such that the battery, in its inwardly rotated position, is clamped, that is to say, braced, between the locating edge and the clamping projections. By means of the said clamping action the battery is held in the frame tube without any clearances, so that no annoying noises, in particular rattling noises, develop, even when riding over uneven ground.

In a further development in the design of the invention, at least one clamping projection is designed as a curved guide track for purposes of curved guidance of at least one mating part. In particular the bounding surfaces have guide tracks, by means of which corresponding mating parts of the battery, which engage with the guide track, can be guided along a curve. A battery can, for example, have mating parts designed as projections on its end faces, which can engage with the guide track. These mating parts can in particular be designed as sliding parts, sections of which can slide along the guide tracks. For purposes of receiving a battery into the recess of a frame tube in one or more sections, the battery is located on a long edge, in particular a locating edge, of the recess, and is rotated about the locating edge such that the mating parts engage with the guide tracks of the end faces of the recess. In particular the mating parts can have a shape that is matched to the shape of the guide tracks. As a result of the curved shape of the guide tracks the battery is rotated laterally into the recess of the frame tube.

In a further development of the vehicle frame at least one guide track has two side walls, the walls are arranged parallel to one another in at least one or more sections, the walls have an end connection with one another, and the walls have a curved shape in at least in one or more sections. A mating part, in particular a mating part designed as a sliding part, which, for example, is arranged on a bounding surface of a battery, can be guided between the walls of the guide track, arranged parallel to one another in at least one or more sections. The final position that is to be achieved so as to ensure secure retention of the battery in the recess of the down tube, can be defined by an end connection of the walls with one another. By means of the end connection a guide track has a U-form shape. The guidance between the walls of the guide track prevents any lateral shift of the mating part. In its final position the battery is clamped between the guide tracks and the locating edge. As a result of the clearance-free accommodation of the battery in the housed state, any noise generation when riding is eliminated.

In a further development the vehicle frame has two bounding surfaces, and the frame tube has two locating edges, arranged between the bounding surfaces, for purposes of locating the energy storage device. The locating edges can, for example, be formed by the edges of the frame tube, one or more sections of which bound the recess for purposes of housing a battery. The locating edges are preferably designed to be approximately parallel to the outer contour of the frame tube. For purposes of housing an energy storage device, in particular a battery, the latter can be located on a locating edge, such that the mating parts on the end faces of the battery, which can be designed, for example, as projections, engage with the guide tracks of the end faces of the recess. By means of a rotation of the battery about the locating edge in the direction of the down tube, the free-standing longitudinal edge of the battery abuts onto the free locating edge of the down tube, on which the battery is not located. As a result of the guidance by means of the guide track, sections of the battery hereby describe a curved path. In its final position the battery is arranged between the locating edges of the down tube in at least one or more sections. As a result of the location on the locating edge, and the rotation of the battery on a curved path, a particularly high contact pressure can be generated by the battery on the locating edge, such that the battery is clamped between the locating edge and the guide tracks. As a result of the high contact pressure of the battery on the locating edge and the clearance-free clamping action, any slippage of the battery is eliminated, even when riding over very uneven ground. Any annoying generation of noise, for example, rattling noises as a result of relative movement between the battery and the bicycle frame, is eliminated.

In a further development of the invention the frame tube has a region of flat design between the locating edges. By means of the region of flat design arranged between the locating edges, for example, the volume of the down tube can be restricted in at least one or more sections. The flat region is arranged between the locating edges and the end faces of the recess such that, by means of the region of flat design, the recessed volume of the down tube is restricted on one side. At the same time at least one outer edge of the end faces bounding the recess is arranged parallel to the flat region. In particular, in the housed state, an outer wall of the battery can be arranged parallel to the flat region. For example, a contact unit, for purposes of making electrical contact with the battery, can be arranged on the region of flat design of the frame tube. The contact between the contact unit and the battery can be made with the battery in its final position.

In a further development of the invention, at least one bounding surface has a latching unit for purposes of making a latching connection with an energy storage device. The latching unit can, for example, form a latching lug by means of a component that is mounted in a sprung manner. The energy storage device, in particular the battery, can preferably have a depression on one of its end faces, with which the component mounted in a sprung manner, in particular the latching lug, engages in the final housed position of the battery. By making a latching connection between the battery and the frame tube additional security is provided for the battery against any inadvertent removal of the battery from the vehicle frame.

In a further development of the invention the latching unit is arranged between the walls of the at least one guide track. The latching unit, with for example a latching element mounted in a sprung manner, can be arranged between the walls of a guide track such that a latching connection can be made with a mating part of a battery, that is guided between the walls. For this purpose a mating part can, for example, have a depression, with which the latching element engages so as to make a latching connection.

In a further development of the design of the invention the latching unit is designed as a latching element that is of an elastic design in at least one or more sections. The elastic latching element can, for example, take the form of a component made of spring steel, or similar. During the process of rotating the energy storage device into position, the latching element can, for example, be pushed by a mating part arranged on the energy storage device into a depression on the bounding surface of the recess. In the housed state the latching element, in particular, a latching lug, can engage with a depression of the battery such that a latching connection is made. Here the latching element is preferably designed in the form of a lamella, and has a connection on one side with the end face of the frame tube, such that a flexible, that is to say, sprung mounting of the latching element is provided.

In a further development of the design of the invention at least one bounding surface is designed as a component connected with the vehicle frame. The components can preferably be of a flat design. The components can preferably be connected with the frame tube of the vehicle frame by means of screwed connections. Other options for connection, such as, for example, clip connections, latching connections, or adhesive connections, are also possible. The components preferably consist of plastic, as a result of which a particularly simple and cost-effective production of the components is made possible. In particular the plastic components allow the arranged guide tracks to be moulded into the component easily.

In a further development of the invention the frame tube has at least one locking unit and the locking unit has at least one locking bar. The locking unit can, for example, be designed as a locking cylinder with an assigned locking bar. The locking unit can at the same time be arranged such that locking of the energy storage device, in particular a battery, housed in the recess, is made possible by the locking bar. In this manner the battery located on a frame tube can be secured against any unwanted removal, in particular against theft. For example, the key aperture of the locking cylinder can be arranged on the side of the down tube, such that simple operation by the user is made possible.

In a further development of the design of the invention at least one bounding surface has at least one opening for purposes of allowing a locking bar to pass through. By means of the opening a locking bar can be guided through the bounding surface, preferably at right angles to the plane of the bounding surface. By allowing the locking bar to pass through, for example, a battery located on the bounding surfaces can be secured. To this end the battery can have an opening with which the locking bar can engage. It is also possible for the battery to have a projection on a corresponding end face and for the locking bar in the locked state to lock the latter into position, and thus prevent a removal of the battery.

In a preferred form of embodiment of the invention the frame tube having a recess takes the form of a down tube. The housing of the energy storage device in the down tube of a bicycle frame is especially advantageous, since the down tube can be embodied so as to be particularly robust, and a particularly simple removal of the battery is provided.

Furthermore the invention concerns an energy storage device for an inventive vehicle frame, in which provision is made, in a manner significant for the invention, for the energy storage device to have at least two end faces, and for at least one end face to have at least one mating part for purposes of guidance in a guide track of the vehicle frame. An energy storage device can, for example, be designed as a battery. The energy storage device has two end faces on which are arranged mating parts, for purposes of introduction into the guide tracks of the vehicle frame. The guide tracks can be arranged on the bounding surfaces of a recess of the bicycle frame provided for purposes of housing the energy storage device. By locating an edge, for example, a longitudinal edge, of the energy storage device, on a locating edge of the bicycle frame, a mating part of the energy storage device can be introduced into the guide track of the bicycle frame. Guided by means of the guide tracks, the energy storage device is rotated into the recess in the frame tube, and is clamped, that is to say braced, between the locating edge and the guide track. In this manner a clearance-free housing of the energy storage device in the frame tube is provided.

In a further development at least one mating part has a curved shape in at least one or more sections. The guide tracks of the bicycle frame can have a curved shape, such that by means of a matched curved shape of the mating parts secure guidance is ensured.

### BRIEF DESCRIPTION OF THE DRAWINGS

An example of embodiment of the invention, from which further inventive features ensue, is represented in the figures. Here:

FIG. 1 shows a schematic representation of a bicycle with an inventive vehicle frame, and a related energy storage device;

FIG. 2 shows a schematic representation of an inventive vehicle frame, with a related energy storage device in the located state;

FIG. 3 shows a schematic representation of an inventive vehicle frame, with a related energy storage device housed in the frame tube;

FIG. 4 shows a schematic partial view of the recess of the frame tube; and

FIG. 5 shows a schematic representation of a battery to be housed in the frame tube.

### DETAILED DESCRIPTION OF THE PREFERRED EMBODIMENTS

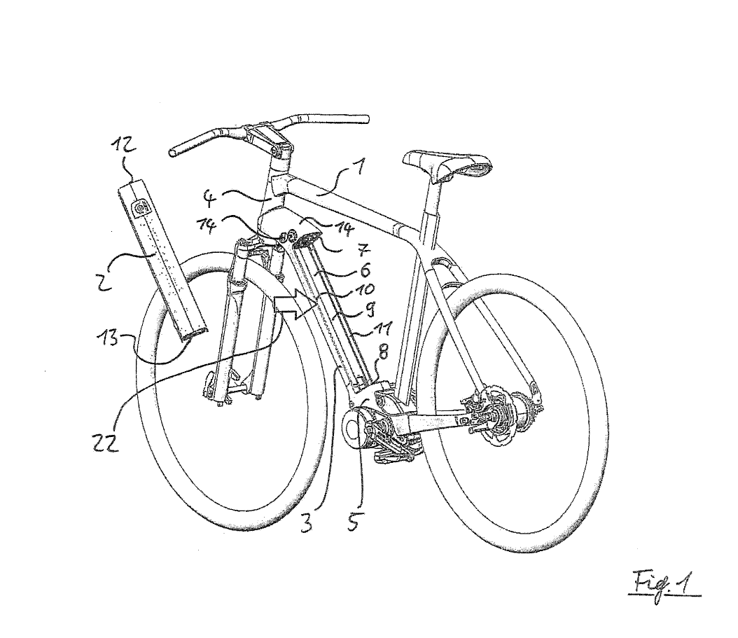

FIG. 1 represents an inventive vehicle frame, in particular a bicycle frame 1, with a related energy storage device 2 designed as a battery. The bicycle frame 1 has a frame tube 3, in particular a down tube, which represents a connection between the head tube 4 and the bottom bracket bearing housing 5. The frame tube 3 has a recess 6, which is bounded by the bounding surfaces 7 and 8 in one or more sections. The frame tube 3 has a region of flat design 9 between the bounding surfaces 7, 8. The locating edges 10, 11 are arranged parallel to the region 9. The energy storage device 2, represented in the non-installed state, has two end faces 12, 13. In addition, the frame tube 3 has a locking unit 14 for purposes of locking the energy storage device 2 in the installed state. The position for receiving the energy storage device 2 into the frame tube 3 is indicated by the arrow 22.

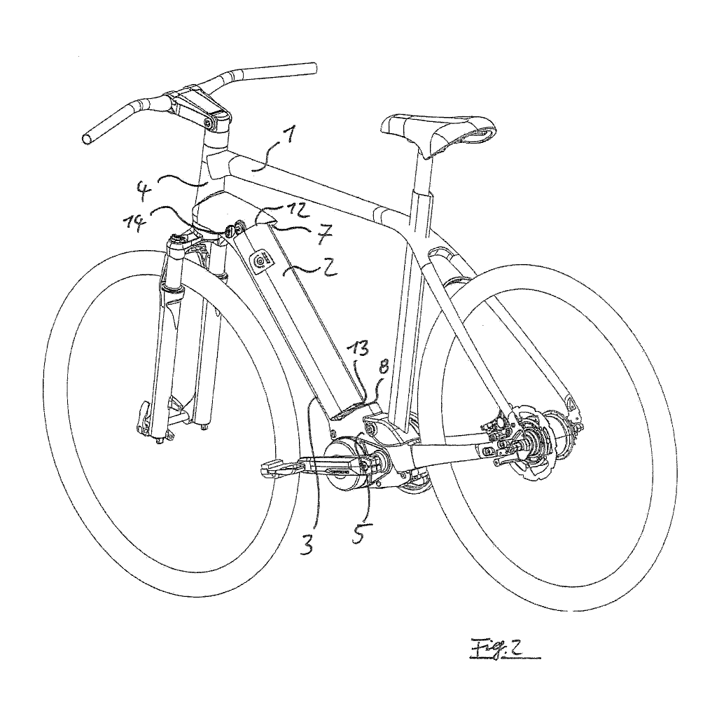

FIG. 2 represents an inventive bicycle frame 1 in accordance with FIG. 1 with an energy storage device 2 in the located state. The same components are provided with the same reference symbols. In the state represented the energy storage device 2 is located on a locating edge 10 of the frame tube 3. By a rotation of the energy storage device 2 in the direction of the locating edge 11, the energy storage device 2 is brought into the housed state.

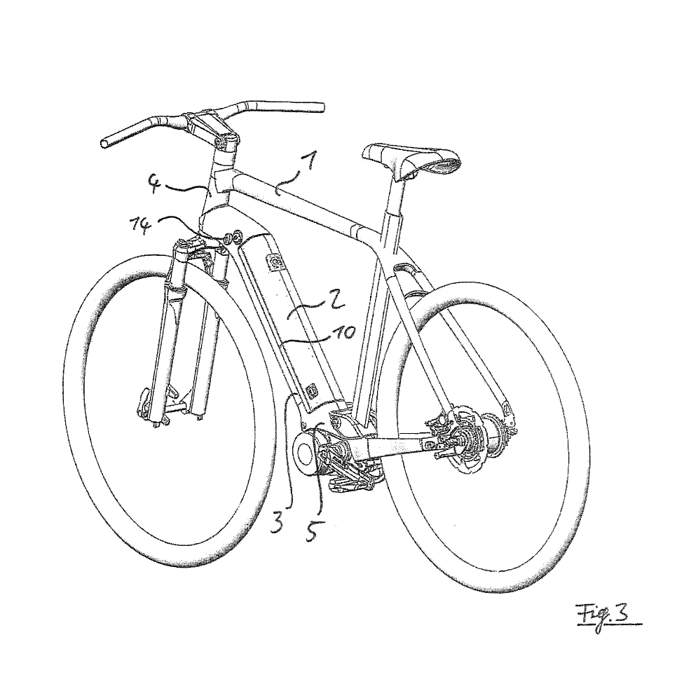

FIG. 3 represents the inventive bicycle frame 1 in accordance with FIGS. 1 and 2 with a housed energy storage device 2. The energy storage device 2 is received into the recess 6 of the bicycle frame 1. As a result of the location onto the locating edge 10, a particularly high contact pressure can be ensured as the energy storage device is rotated in, so that any movement of the energy storage device relative to the frame tube 3 is eliminated, even when riding over uneven ground. The energy storage device 2, received into the recess 6, integrates into the frame tube 3 in a form fit, so that the visual appearance of the bicycle frame 1 is not negatively affected by the energy storage device 2.

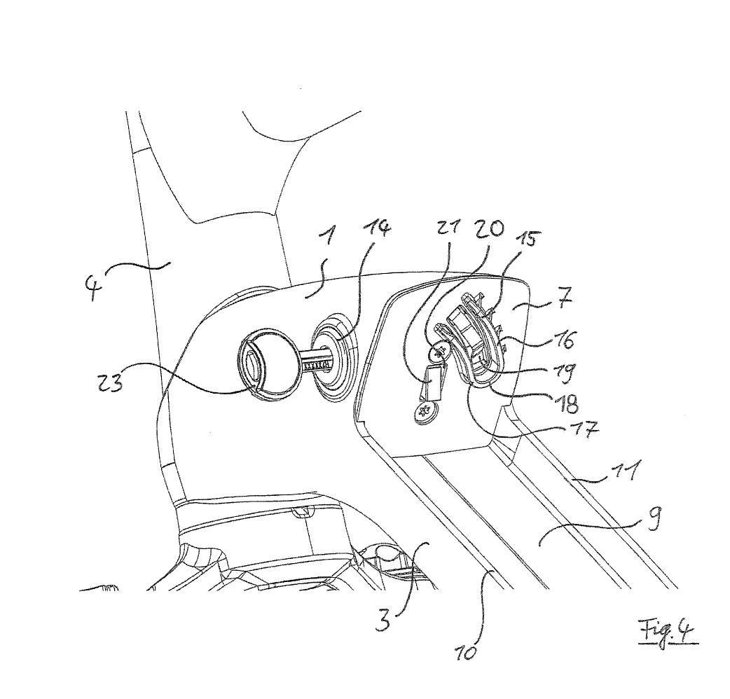

In FIG. 4 the recess 6 is represented in a partial view, together with a bounding surface 7 of the frame tube 3. The bounding surface 7 has a clamping projection designed as a guide track 15. The guide track 15 is formed by side walls 16, 17, which have an end connection 18. The guide track 15 with the side walls 16, 17 has a curved shape. After location on a locating edge 10, a mating part 24 on an energy storage device 2 can be guided by means of the guide track 15 along a curve into the housed position of the energy storage device 2. In addition, the bounding surface 7 has a latching element 19, which is provided for purposes of making a latching connection with the energy storage device 2. To this end the latching element 19 is mounted in a sprung manner, such that, as a mating part 24 of the energy storage device 2 is guided between the walls 16, 17 of the guide track 15, it pivots back so as to latch with a depression 25 in the energy storage device 2. Furthermore, the bounding surface 7 has an opening 20 to allow a locking bar 21 to pass through. The locking bar 21 is connected with a locking unit 14, which can be operated a means of a key 23. In the housed state of the energy storage device 2 the locking bar 21 can be brought by the locking unit 14 into a locked state, wherein the locking bar 21 grips behind a projection 26 of the energy storage device 2 and locks the latter into position. In this manner any unwanted removal of the energy storage device 2 from the frame tube 3 is eliminated. The locating edges 10 and 11 protrude above the flat region 9 of the frame tube 3. Between the said locating edges 10, 11 sections of the energy storage device 2 are housed, and the energy storage device 2 is, moreover, clamped between the locating edge 10 and the guide track 15, as a result of which particularly good protection of the energy storage device 2 against movements relative to the frame tube 3 is provided.

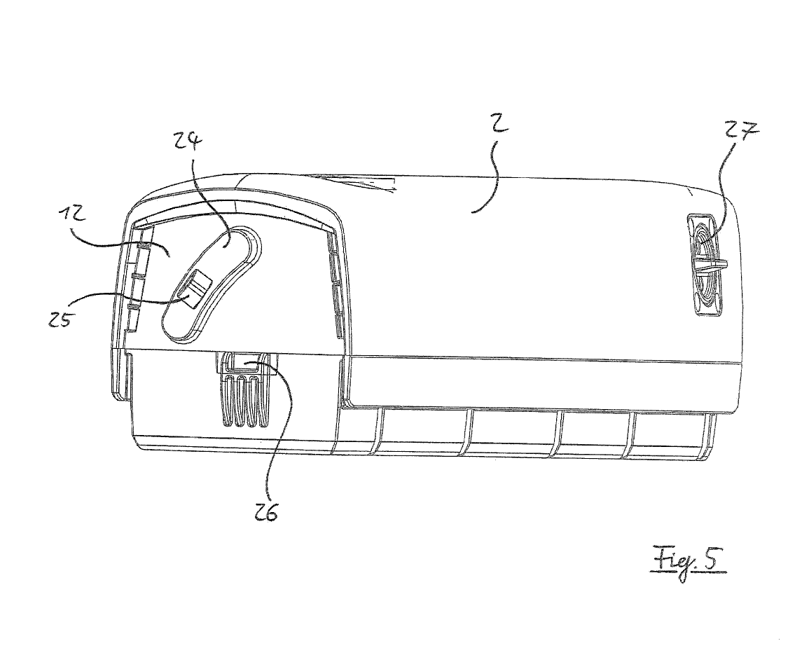

FIG. 5 represents an energy storage device 2 to be housed in a frame tube 3 of an inventive bicycle frame 1. The energy storage device 2 has two end faces 12, 13. The guide track 12 has a mating part 24, which is designed as a projection with a curved shape. The mating part 24 has a depression 25, with which the latching element 19 of the bicycle frame 1 can engage in the housed state of the energy storage device 2. In addition, the end face 12 has a projection 26, which in the housed state of the energy storage device 2 can be locked in position by the locking bar 21. As a result of the interaction between the locking bar 21 and the projection 26, any unwanted removal of the energy storage device 2 from the down tube 3 is eliminated. A cover element 27 is arranged on the side of the energy storage device 2, under which cover element 27 a connecting part can be arranged for a power supply for purposes of charging the energy storage device 2.

All of the features cited in the above description and in the claims can be combined in any manner of selection with the features of the independent claim. Thus the disclosure of the invention is not limited to the described or claimed combinations of features, but rather all reasonable combinations of features are to be considered as disclosed within the context of the invention.

1. A vehicle frame, in particular a bicycle frame, with frame tubes, in particular with a seat tube and a down tube, wherein:
at least one frame tube has at least one mounting for at least one energy storage device,
the at least one mounting is designed as a recess of at least one frame tube,
the frame tube has at least one bounding surface, bounding the recess in at least one sections,
the frame tube has a locating edge bounding the recess in at least one or more sections, and
at least one bounding surface has at least one clamping projection.

2. The vehicle frame in accordance with claim 1, wherein at least one clamping projection is designed as a curved guide track for the curved guidance of at least one mating part.

3. The vehicle frame in accordance with claim 2, wherein at least one guide track has two side walls, the walls are arranged parallel to one another in at least one or more sections,
the walls have an end connection with one another, and
the walls have a curved shape in at least one or more sections.

4. The vehicle frame in accordance with claim 1, wherein the frame tube has two bounding surfaces, and the frame tube has two locating edges arranged between the bounding surfaces, for purposes of locating an energy storage device.

5. The vehicle frame in accordance with claim 4, wherein the frame tube has a region of flat design between the locating edges.

6. The vehicle frame in accordance with claim 1, wherein at least one bounding surface has a latching unit for purposes of making a latching connection with an energy storage device.

7. The vehicle frame in accordance with claim 6, wherein the latching unit is arranged between the walls of at least one guide track.

8. The vehicle frame in accordance with claim 6, wherein the latching unit is designed as a latching element that is of an elastic design in at least one or more sections.

9. The vehicle frame in accordance with claim 1, wherein at least one bounding surface is designed as at least one component connected with the vehicle frame.

10. The vehicle frame in accordance with claim 1, wherein the frame tube has at least one locking unit, and the locking unit has at least one locking bar.

11. The vehicle frame in accordance with claim 10, wherein at least one bounding surface has at least one opening to allow a locking bar to pass through.

12. The vehicle frame in accordance with claim 1, wherein the frame tube having a recess takes the form of a down tube.

13. An energy storage device for a vehicle frame in accordance with claim 1,
wherein,
the energy storage device has at least two end faces, and at least one end face has at least one mating part for purposes of guidance in a guide track of the vehicle frame.

14. The energy storage device for a vehicle frame in accordance with claim 13, wherein, at least one mating part has a curved shape in at least one or more sections.
